(19) United States
(12) Patent Application Publication
(10) Pub. No.: US 2007/0284185 A1
(43) Pub. Date: Dec. 13, 2007

(54) Damped structural panel and method of making same

(76) Inventor: Gary C. Foss, Covington, WA (US)

Correspondence Address: KLEIN, O'NEILL & SINGH, LLP, 43 CORPORATE PARK, SUITE 204, IRVINE, CA, 92606, US

(21) Appl. No.: 11/448,334

(22) Filed: Jun. 7, 2006

(51) Int. Cl. F16F 15/00

(52) U.S. Cl. 181/207

(57) ABSTRACT

A damped structural panel is provided. The damped structural panel comprises a base layer, having a rear surface and a front surface; wherein a viscous fluid is applied on the rear surface of the base layer; and a rigid supporting layer is secured to the base layer over the viscous fluid.

### BACKGROUND OF THE INVENTION

1. Field of the Invention

This invention relates to damped structural panels and methods of making damped structural panels.

2. Background

Noise and vibration are inherent in moving vehicles, commercial airplanes, launch vehicles (for example Delta launch or Sea Launch vehicles) and fighter aircrafts (such as F-15 and F-18 aircrafts). Aircraft fuselage panels, panels of automobiles and panels found in appliances (also referred to as “structural panels”) suffer structural vibration when exposed to noise and vibration. Excessive structural vibration when left unchecked, can cause discomfort and damage. It can also lead to failure of structural components and sensitive electronics in airplanes, launch vehicles and fighter aircrafts.

Damping refers to the extraction of mechanical energy from a vibrating structure, usually by conversion of kinetic energy into heat. Damping dissipates vibrational energy in the structure before it can build up to excessive levels resulting in acoustical problems or structural failure. If a structure does not have enough inherent damping to control vibration, additive damping treatments are frequently applied to selected areas. For optimum results in acoustic noise control, the treatments are used as close to the acoustic source as possible. Vibrating panels or plates are the most common of these sources.

A common additive damping treatment is constrained layer damping (CLD), which consists of a sandwich of two relatively stiff layers with a rubbery viscoelastic material as the core. The structure that needs additional damping (also referred to as the “base structure” or “base layer’ throughout the specification) undergoes bending vibration while the viscoelastic material is deformed in shear. The cyclic deformation of the viscoelastic material removes mechanical energy and reduces the vibration and noise amplitudes.

Conventional damping treatments such as CLD suffer from inherent disadvantages. Viscoelastic material is expensive and adds additional weight to structural panels. Weight of structural panels is an important factor in aviation and other industries.

Therefore, there is a need for damped structural panels and methods of making these structural panels, which provide optimum damping with minimum weight increase.

### SUMMARY OF THE INVENTION

In one aspect of the present invention, a damped structural panel is provided. The damped structural panel comprises a base layer, having a rear surface and a front surface; wherein viscous fluid is applied on the rear surface of the base layer; and a rigid supporting layer is secured to the base layer over the viscous fluid.

In another aspect of the present invention, damped structural panel comprising a thin film of viscous fluid placed between a base layer and a supporting layer is provided.

In yet another aspect of the present invention, a method of making a damped structural panel is provided. The method includes applying a thin film of viscous fluid on rear surface of a base layer; and securing a rigid supporting layer on the base layer.

In yet another aspect of the present invention, a damped aircraft panel is provided. The damped aircraft panel comprises a base layer, having a rear surface and a front surface; wherein viscous fluid is applied on the rear surface of the base layer; and a rigid supporting layer is secured to the base layer over the viscous fluid.

This brief summary has been provided so that the nature of the invention may be understood quickly. A more complete understanding of the invention can be understood by reference to the following details description of the preferred embodiments of thereof in connection with the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following figures.

FIG. 1A shows a cross sectional view of a damped structural panel, according to one aspect of the present invention.

FIG. 1B illustrates typical redistribution of the fluid as the base structure deflects during vibration, according to one aspect of the present invention.

FIG. 2 shows comparative performance of the damped structural panel of present invention, performance of a typical commercial product, and performance with no damping treatments.

FIGS. 3A and 3B show a flow chart of a process for making damped structural panels, according to one aspect of the present invention.

### DETAILED DESCRIPTION OF THE INVENTION

In one aspect of the present invention, a damped structural panel is provided. The damped structural panel of the present invention uses viscous fluid trapped between a base layer and supporting layer, and relies on cyclic forced flow of the fluid to dissipate vibration energy. The damped structural panel of the present invention can be inexpensively manufactured, is light and provides optimum damping.

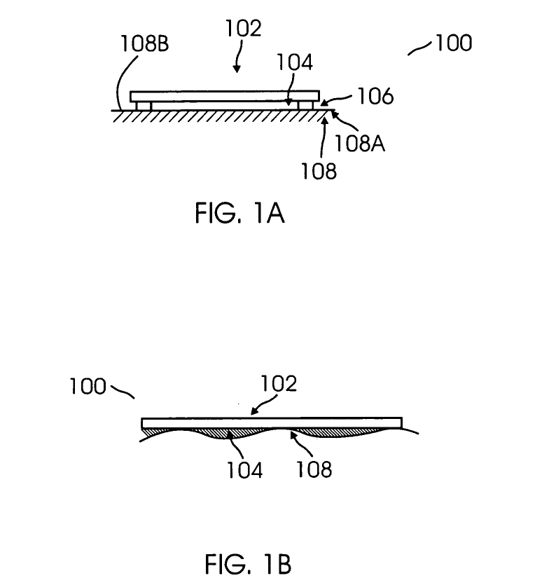

FIG. 1A shows a cross section of the damped structural panel 100, according to one aspect of the present invention. Damped structural panel 100 comprises a thin film of viscous fluid 104 trapped between two closely spaced layers, base layer 108 and rigid supporting layer 102 (also referred to as supporting layer). Base layer 108 is the structure that needs damping.

Base layer 108 is a relatively thin vibrating membrane, like thin shell or panel like structure. In a peferred embodiment, skin of an aircraft panel acts as a base layer 108. Base layer 108 has a rear surface 108B and a front surface 108A. Rear surface 108B of the base layer 108 is covered with viscous fluid 104.

Viscous fluid 104 is chosen to provide maximum damping performance over a desired temperature range, which depends on the fluid's viscosity. For example, heavy gear oil provides optimum damping at approximate cruising altitude temperatures of a commercial aircraft fuselage skin. A soft grease or gel has an optimum viscosity for room temperature performance.

A small amount of viscous fluid is inserted between base layer 108 and supporting layer 102. The amount of viscous fluid 104 should be sufficient to wet rear surface 108B. Also, surface tension of viscous fluid 104 should be sufficient to keep the fluid in place.

Supporting layer 102 is a thin, rigid panel adhered to the edges of base layer 108 by conventional means, such as adhesives (106). Supporting layer 102 is made from a stiff material having high stiffness to weight ratio and may be flat sheet or a stiffened structure such as a T-Section or ribbed sheet. Supporting layer 102 with the help of adhesives 106, seals the viscous fluid 104, without any spills or leakage.

Base layer 108 and supporting layer 102 conform in shape and size to each other. These layers (108 and 102) could be either flat or curved.

Damping action in the structure of FIG. 1A is induced by forced vibration of either base layer 108 or supporting layer 102. Base layer 108, being a thin membrane, vibrates at different discrete frequencies. This vibration depends on mass and stiffness distribution across the structural panel 100. At any instant, some regions of the base panel 108 will be moving towards supporting layer 102, and some will be moving away. This repeated motion causes areas of higher and lower pressure in viscous fluid 104, which induces back and forth flow. The cyclic flowing of viscous fluid 104 dissipates vibration energy as a small amount of heat, causing the vibration to be reduced. This also has the effect of reducing sound and noise radiation by the structural panel. As viscous fluid 104 exerts forces normal to supporting layer 102 it is important that the supporting layer 102 is stiff and rigid. Ribs or honeycomb may be added to supporting layer 102 to increase the bending strength and improve performance.

FIG. 1B illustrates movement of viscous fluid 104 in damped structural panel, according to one aspect of the present invention. Forced vibration causes changes in the thickness profile of the viscous fluid 104, which induces movement of viscous fluid 104. As discussed above, cyclic movement of the viscous fluid 104 dissipates energy in the form of heat, thereby reducing vibration. This also reduces the sound and noise radiation by the structural panel.

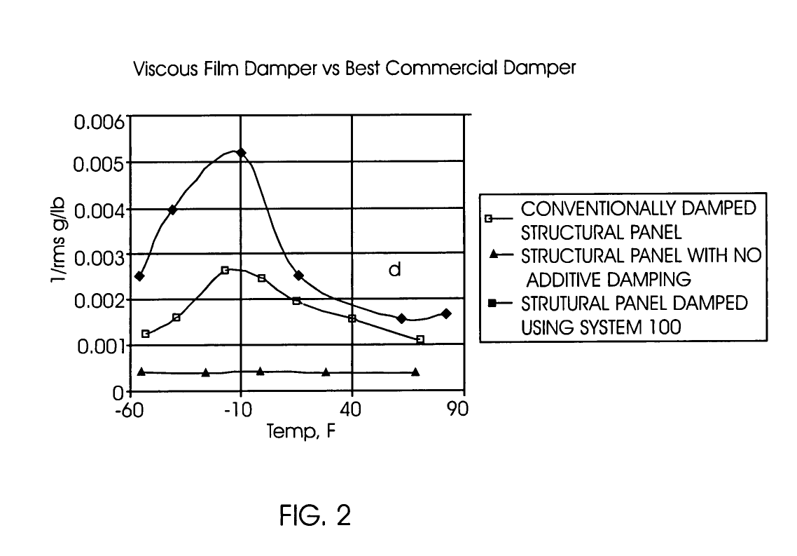

FIG. 2 shows the comparative performance of a damped structural panel of the present invention with a conventional damped structural panel. FIG. 2 also compares performance of a structural panel without any damping treatments. The vertical scale represents the inverse of the average normalized response of a test panel over a frequency range of 100-3000 HZ. A larger number represents a lower response per unit input. Damped structural panels of the present invention provide better damping than panels with conventional additive damping devices.

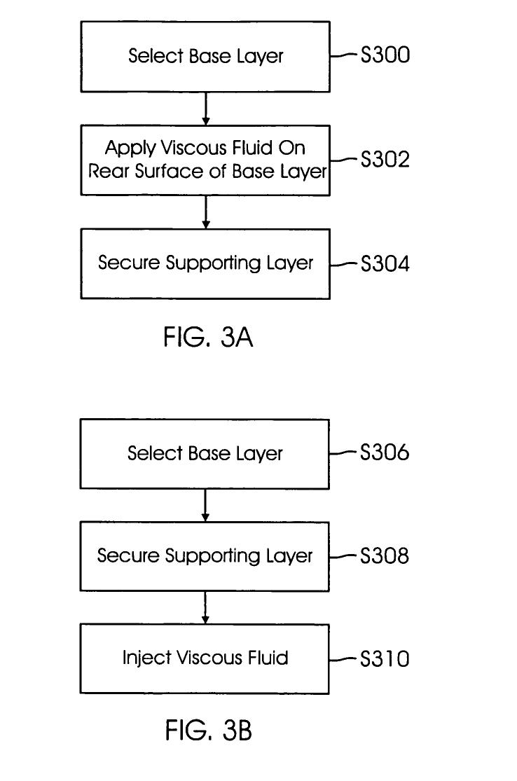

FIG. 3A shows a flow diagram for method of making damped structural panels. In step S300, a base layer 108 is selected. Base layer 108 is the structure that requires damping, like the fuselage of an airplane.

In step S302, a thin film of viscous fluid 104 is applied on the rear surface 108B of base layer 108. In step S304, a supporting layer 102 is secured to the edges of the rear surface 108B of the base layer 108. Conventional adhesives or sealants 106 are used for securing supporting layer 102 over base layer 108, forming a damped structural panel 100.

In an another embodiment of the present invention, as shown in FIG. 3B, after selecting a base layer 108 in step S306, a rigid supporting layer 102 is secured to the rear surface of the base layer 108 in Step S308. In step S310, a viscous fluid 104 is injected between base layer 108 and supporting layer 102, to form damped structural panel 100.

In another aspect of the present invention, a damped aircraft panel is provided (not shown). The damped aircraft panel comprises a thin viscous fluid 104 trapped between closely spaced base layer 108 and rigid supporting layer 102.

As will be evident to persons of skill in the art, damped structural panels of the present invention may find use in building industry for blocking street noise or to dampen the noise in ventilation systems. It may also find use in ship building industry, in vehicles or in general domestic applications other than airplanes. All such uses are within the scope of the present invention.

Accordingly, the scope of the preset invention should not be limited to the particular embodiments illustrated and described herein, as they are merely exemplary in nature, but rather, should be fully commensurate with that of the claims appended hereafter and their functional equivalents.

What is claimed is:

1. A damped structural panel comprising:
a base layer, having a rear surface and a front surface; wherein a viscous fluid is applied on the rear surface of the base layer; and a rigid supporting layer is secured to the base layer over the viscous fluid.

2. The damped structural panel of claim 1, wherein the viscous fluid is chosen to provide maximum damping performance over a desired temperature range.

3. The damped structural panel of claim 1, wherein the base layer is an aircraft structure.

4. The damped structural panel of claim 1, wherein the rigid supporting layer has high stiffness to weight ratio.

5. A damped structural panel comprising: a thin film of viscous fluid placed between a base layer and a supporting layer.

6. The damped structural panel of claim 5, wherein the viscous fluid provides maximum damping performance over a desired temperature range.

7. The damped structural panel of claim 5, wherein the base layer is an aircraft structure.

8. The damped structural panel of claim 5, wherein the rigid supporting layer has high stiffness to weight ratio.

9. A method of making a damped structural panel comprising:
applying a thin film of a viscous fluid on rear surface of a base layer; and
securing a rigid supporting layer on the base layer.

10. The method of claim 9, wherein the viscous fluid provides maximum damping performance over a desired temperature range.

11. The method of claim 9, wherein the base layer is an aircraft structure.

12. The method of claim 9, wherein the rigid supporting layer has high stiffness to weight ratio.

13. A damped aircraft panel comprising:
a base layer, having a rear surface and a front surface; wherein a viscous fluid is applied on the rear surface of the base layer; and a rigid supporting layer is secured to the base layer over the viscous fluid.

14. The damped aircraft panel of claim 13, wherein the viscous fluid provides maximum damping performance over a desired temperature range.

15. The damped aircraft panel of claim 13, wherein the base layer is an aircraft structure.

16. The damped aircraft panel of claim 13, wherein the rigid supporting layer has high stiffness to weight ratio.
